(19) United States
(12) Patent Application Publication
(10) Pub. No.: US 2025/0130579 A1
(43) Pub. Date: Apr. 24, 2025

(54) AUTONOMOUS MOBILE BODY

(71) Applicant: AISIN CORPORATION, Kariya (JP)

(72) Inventors: Masashi NOBUTOKI, Kariya-shi (JP); Shintaro SUZUKI, Kariya-shi (JP); Tetsuhiro MAKI, Kariya-shi (JP); Wataru TAKAYANAGI, Kariya-shi (JP); Toshihiko ISHIDA, Kariya-shi (JP)

(73) Assignee: AISIN CORPORATION, Kariya (JP)

(21) Appl. No.: 18/917,360

(22) Filed: Oct. 16, 2024

(30) Foreign Application Priority Data
Oct. 23, 2023 (JP) 2023-181967

(51) Int. Cl. G05D 1/43; B62D 63/04; G05D 109/10

(52) U.S. Cl. CPC G05D 1/43; B62D 63/04; G05D 2109/10

(57) ABSTRACT

An autonomous mobile body includes: a traveling unit including a drive wheel and a chassis and configured to move straight and turn and move in a left and right; a second unit disposed at an upper portion of the traveling unit and including a top plate and an oscillating mechanism for performing oscillating motion of moving around a vertical axis with reference to the traveling unit; and a control unit configured to, upon causing the autonomous mobile body to move to a destination, when the autonomous mobile body turns and moves in either a left direction or a right direction, execute control to cause the second unit to perform oscillating motion in the same direction to bring the second unit into an oscillating state, and to perform oscillating motion in an opposite direction before changing from turning movement to straight movement to cause the second unit to return from the oscillating state to a non-oscillating state.

### CROSS REFERENCE TO RELATED APPLICATIONS

This application is based on and claims priority under 35 U.S.C. § 119 to Japanese Patent Application 2023-181967, filed on Oct. 23, 2023, the entire content of which is incorporated herein by reference.

### TECHNICAL FIELD

This disclosure relates to an autonomous mobile body.

### BACKGROUND DISCUSSION

In the related art, research and development of autonomous traveling robots capable of transporting objects such as food and drink and luggage have been performed. When a destination is located diagonally forward to a right of a current position, for example, the autonomous traveling robot moves straight forward until a position where the destination and a front-rear position coincide with each other, then turns 90° to the right so as to directly face the destination, and then moves straight toward the destination. Alternatively, the autonomous traveling robot calculates a traveling trajectory connecting the current position and the destination, and reaches the destination by tracing the calculated traveling trajectory.

On the other hand, when an employee at a restaurant or the like brings food to a place of a customer, if the customer is present diagonally forward to a right of the employee, the employee first changes a direction of his or her face to a direction of the customer to visually recognize a position of the customer as a destination, and then gradually changes a direction of his or her body to approach the customer. In this case, the customer can recognize at an early stage that the employee is facing the place of the customer himself or herself from the direction of the face of the employee.

Examples of the related art include JP 5768273B (Reference 1).

However, considering that an autonomous traveling robot is used instead of the above-described employee, the autonomous traveling robot does not perform an operation of turning a face toward the customer at an early stage, as the employee does. Therefore, the customer cannot recognize at an early stage that the autonomous traveling robot is moving toward the place of the customer, and there is room for improvement.

A need thus exists for an autonomous mobile body which is not susceptible to the drawback mentioned above.

### SUMMARY

An autonomous mobile body according to the present embodiment includes: a traveling unit including a drive wheel and a chassis and configured to move straight and turn and move in a left and right; a second unit disposed at an upper portion of the traveling unit and including a top plate and an oscillating mechanism for performing oscillating motion of moving around a vertical axis with reference to the traveling unit; and a control unit configured to, upon causing the autonomous mobile body to move to a destination, when the autonomous mobile body turns and moves in either a left direction or a right direction, execute control to cause the second unit to perform oscillating motion in the same direction to bring the second unit into an oscillating state, and to perform oscillating motion in an opposite direction before changing from turning movement to straight movement to cause the second unit to return from the oscillating state to a non-oscillating state.

### BRIEF DESCRIPTION OF THE DRAWINGS

The foregoing and additional features and characteristics of this disclosure will become more apparent from the following detailed description considered with the reference to the accompanying drawings, wherein:

FIGS. 1A and 1B are diagrams showing a structure of an autonomous traveling robot according to an embodiment;

FIG. 2 is a diagram showing a functional configuration of the autonomous traveling robot according to the embodiment;

FIG. 3 is a diagram showing an operation example of the autonomous traveling robot according to the embodiment; and

FIG. 4 is a flowchart showing processing executed by the autonomous traveling robot according to the embodiment.

### DETAILED DESCRIPTION

Hereinafter, an autonomous traveling robot (autonomous mobile body) according to the present embodiment will be described with reference to the drawings. In the following description, “front-rear (direction)” indicates a direction parallel to a traveling direction of the autonomous traveling robot. “Left-right (direction)” is a direction perpendicular to the traveling direction of the autonomous traveling robot and parallel to a ground.

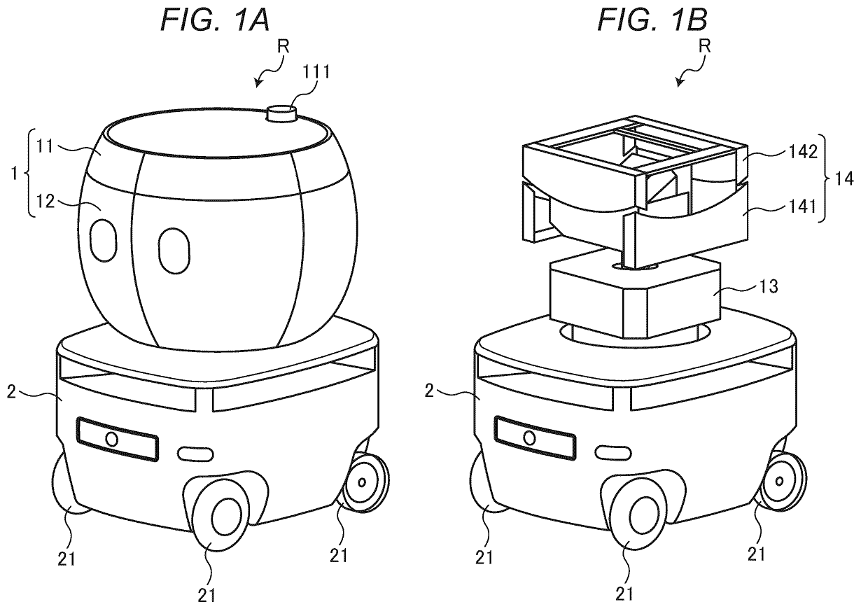

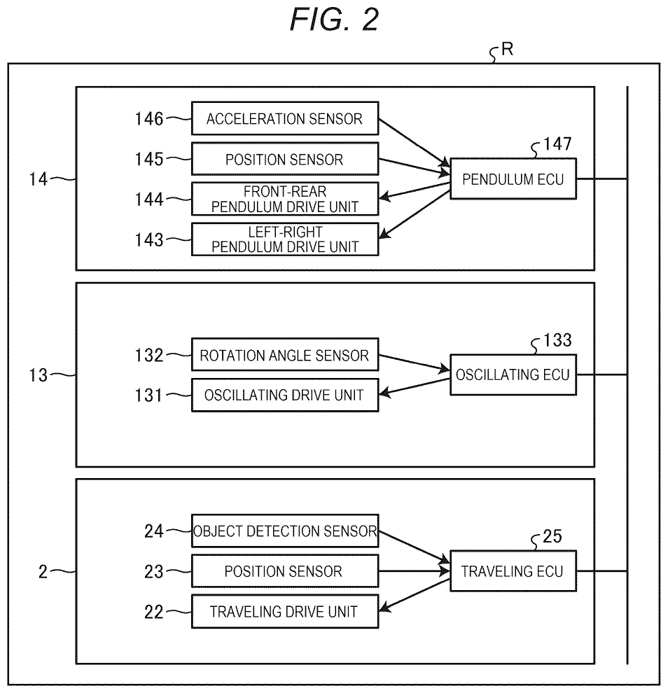

First, a structure and a functional configuration of an autonomous traveling robot R will be described with reference to FIGS. 1A to 2. FIGS. 1A and 1B are diagrams showing the structure of the autonomous traveling robot R according to the embodiment. FIG. 2 is a diagram showing the functional configuration of the autonomous traveling robot R according to the embodiment.

FIG. 1A is an external view of the autonomous traveling robot R. The autonomous traveling robot R can transport objects such as food and drink and luggage, and autonomously moves within a mobile environment such as a restaurant, a house, a facility, a warehouse, a factory, or an outdoor.

The autonomous traveling robot R includes a transport unit 1 (second unit) and a traveling unit 2. The traveling unit 2 has a substantially rectangular parallelepiped shape with rounded corners, has four drive wheels 21 and a chassis, and is capable of moving straight and turning and moving in a left and right.

The transport unit 1 has a barrel shape and is disposed at an upper portion of the traveling unit 2, and includes an upper body 11 and a lower body 12. A housing of the upper body 11 is fixed to a pendulum mechanism 14 (FIG. 1B) and moves in accordance with movement of the pendulum mechanism 14. A housing of the lower body 12 is fixed to a rotation mechanism 13 (FIG. 1B) and rotates in accordance with rotational movement of the rotation mechanism 13.

FIG. 1B is a diagram showing an internal structure of the transport unit 1 of the autonomous traveling robot R. That is, in FIG. 1B, a housing portion of the upper body 11 and a housing portion of the lower body 12 shown in FIG. 1A are not shown. The transport unit 1 includes the rotation mechanism 13 and the pendulum mechanism 14.

The rotation mechanism 13 is an oscillating mechanism for performing oscillating motion of moving around a vertical axis with reference to the traveling unit 2.

The pendulum mechanism 14 is a transport mechanism for transporting luggage, and includes a front-rear pendulum mechanism 141 and a left-right pendulum mechanism 142. The front-rear pendulum mechanism 141 is a pendulum mechanism for tilting an upper surface (top plate) of the upper body 11 in the front-rear direction. The left-right pendulum mechanism 142 is a pendulum mechanism for tilting the upper surface (top plate) of the upper body 11 in the left-right direction. An object transported by the autonomous traveling robot R is placed on the upper surface (top plate) of the upper body 11. A mark 111 is attached to the upper surface (top plate) of the upper body 11.

As shown in FIG. 2, the traveling unit 2 includes a traveling drive unit 22, a position sensor 23, an object detection sensor 24, and a traveling ECU 25.

The traveling drive unit 22 includes an electric motor that rotationally drives the drive wheels 21.

The position sensor 23 is a sensor that acquires data for estimating a position of the autonomous traveling robot R by the traveling ECU 25. The position sensor 23 is implemented by, for example, a global positioning system (GPS) sensor and a rotation angular velocity sensor of the drive wheel 21, and transmits a detection signal to the traveling ECU 25.

The object detection sensor 24 is a sensor that detects an object (hereinafter, also referred to as an “obstacle”) around the autonomous traveling robot R. The object detection sensor 24 is implemented by, for example, a light detection and ranging (LiDAR) or a millimeter wave sensor, and transmits a detection signal to the traveling ECU 25. In addition, the object detection sensor 24 may be implemented by a camera, an ultrasonic sensor, an infrared sensor, or the like, or may be a combination of a plurality of units.

The traveling ECU 25 is an information processing device implemented using predetermined hardware and software, and is implemented using, for example, a central processing unit (CPU), a memory, a field programmable gate array (FPGA), and an application specific integrated circuit (ASIC).

The traveling ECU 25 executes various kinds of control. For example, the traveling ECU 25 estimates a current position of the autonomous traveling robot R based on a detection signal acquired from the position sensor 23. The traveling ECU 25 recognizes an obstacle around the autonomous traveling robot R based on a detection signal acquired from the object detection sensor 24. The traveling ECU 25 generates a travel route from a current position to a destination based on the current position, the destination, and a position of the obstacle. The traveling ECU 25 controls the traveling drive unit 22 to cause the traveling unit 2 (and thus the autonomous traveling robot R) to travel along the travel route.

The rotation mechanism 13 includes an oscillating drive unit 131, a rotation angle sensor 132, and an oscillating ECU 133 (control unit).

The oscillating drive unit 131 includes an actuator that rotationally moves the rotation mechanism 13.

The rotation angle sensor 132 is a sensor that detects a rotation angle of the rotation mechanism 13 and transmits a detection signal to the oscillating ECU 133.

The oscillating ECU 133 executes various kinds of control. Upon causing the autonomous traveling robot R to move to a destination by the traveling ECU 25, when the autonomous traveling robot R turns to and moves to either the left direction or the right direction, the oscillating ECU 133 executes control to cause the transport unit 1 to perform oscillating motion in the same direction to bring the transport unit 1 into an oscillating state, and to perform oscillating motion in an opposite direction before changing from turning movement to straight movement to cause the transport unit 1 to return from the oscillating state to a non-oscillating state.

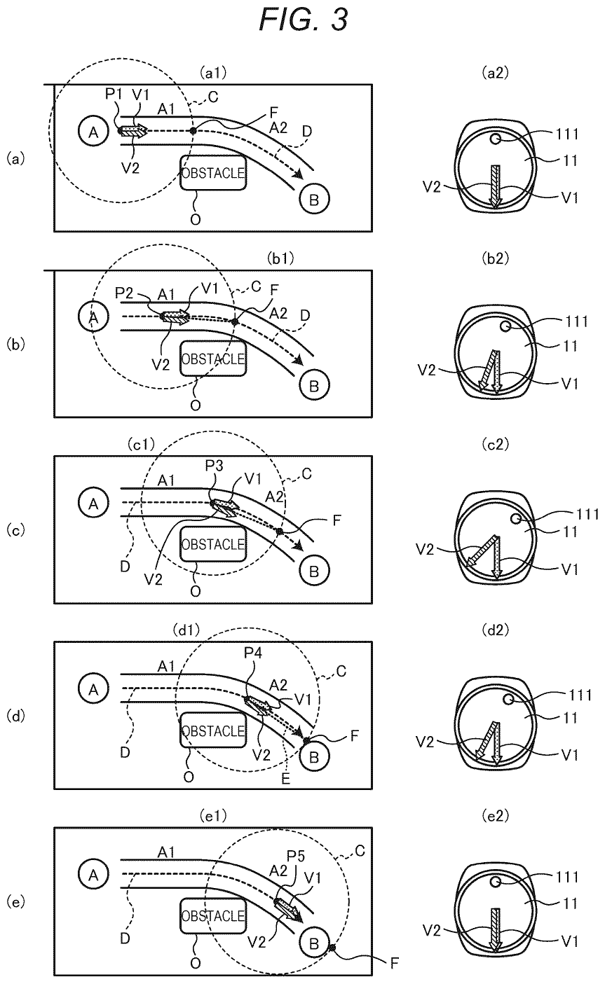

When the autonomous traveling robot R turns to and moves to either the left direction or the right direction, upon causing the transport unit 1 to perform oscillating motion in the same direction to bring the transport unit 1 into an oscillating state, the oscillating ECU 133 executes control to cause the transport unit 1 to perform oscillating motion up to a position where a front surface of the transport unit 1 directly faces the destination at a maximum. Control of the oscillating ECU 133 will be described in detail with reference to FIG. 3. The traveling ECU 25, the oscillating ECU 133, and a pendulum ECU 147 can communicate with each other via a controller area network (CAN) or the like, and transmit and receive necessary information.

FIG. 3 is a diagram showing an operation example of the autonomous traveling robot R according to the embodiment. In the example of FIG. 3, it is assumed that the autonomous traveling robot R moves from a point A to a point B (destination) while avoiding an obstacle O.

In (a1) in FIG. 3, a point P1 indicates a current position of the autonomous traveling robot R (the same applies to points P2 to P5). A travel route D indicates a travel route calculated by the autonomous traveling robot R. A range C indicates a range to be calculated. A point A1 is a start point of a curve on the travel route D. A point A2 is an end point of the curve on the travel route D.

A point F is an intersection of the travel route D and a boundary of the range C. In (a1) and (a2) in FIG. 3, a direction V1 indicates a direction in which (a front surface of) the traveling unit 2 faces, specifically, a tangential direction of the travel route D at the point P1. A direction V2 indicates a direction in which (the front surface of) the transport unit 1 faces, specifically, a direction from the point P1 to the point F.

At a time point in (a) in FIG. 3, a traveling direction portion of the travel route D within the range C is only a linear portion, and the direction V1 and the direction V2 are the same.

Next, at a time point in (b) in FIG. 3, since a traveling direction portion of the travel route D within the range C includes a curved portion, the direction V2 (a direction of a line E from the point P2 to the point F) is a direction slightly inward (right side in the traveling direction) relative to the direction V1.

Next, at a time point in (c) in FIG. 3, since a traveling direction portion of the travel route D within the range C includes many curved portions, the direction V2 (a direction of the line E from a point P3 to the point F) is a direction further inward (right side in the traveling direction) relative to the direction V1 as compared with the time point in (b) in FIG. 3.

Next, at a time point in (d) in FIG. 3, a traveling direction portion of the travel route D within the range C includes a small curved portion, and the direction V2 (a direction of the line E from a point P4 to the point F) is a direction slightly inward (the right side in the traveling direction) relative to the direction V1 as compared with the time point in (c) in FIG. 3.

Next, at a time point in (e) in FIG. 3, a traveling direction portion of the travel route D within the range C is only a linear portion, and the direction V1 and the direction V2 are the same.

Returning to FIGS. 1A to 2, the pendulum mechanism 14 includes a left-right pendulum drive unit 143, a front-rear pendulum drive unit 144, a position sensor 145, an acceleration sensor 146, and the pendulum ECU 147.

When the autonomous traveling robot R turns and moves in the left-right direction, acceleration in the left-right direction occurs in the autonomous traveling robot R, the left-right pendulum drive unit 143 is a mechanism for causing the upper body 11 to perform pendulum motion in the left-right direction so as to cancel out an effect of the acceleration so that an object placed on the upper surface (top plate) of the upper body 11 does not fall in the left-right direction due to the effect of the acceleration.

When the autonomous traveling robot R accelerates or decelerates in the front-rear direction, acceleration in the front-rear direction occurs in the autonomous traveling robot R, the front-rear pendulum drive unit 144 is a mechanism for causing the upper body 11 to perform pendulum motion in the front-rear direction so as to cancel out an effect of the acceleration so that an object placed on the upper surface (top plate) of the upper body 11 does not fall in the front-rear direction due to the effect of the acceleration.

The left-right pendulum drive unit 143 and the front-rear pendulum drive unit 144 can be controlled in parallel. Accordingly, regardless of a direction in which acceleration occurs within 360 degrees around the autonomous traveling robot R, by controlling the left-right pendulum drive unit 143 and the front-rear pendulum drive unit 144 in parallel so as to cancel out the effect of the acceleration, it is possible to prevent an object placed on the upper surface (top plate) of the upper body 11 from falling.

The position sensor 145 is a sensor that acquires data for estimating a position of the pendulum mechanism 14. The position sensor 23 is implemented by, for example, a rotation angular velocity sensor, and transmits a detection signal to the pendulum ECU 147. The position sensor 145 may be provided for each of the front-rear pendulum mechanism 141 and the left-right pendulum mechanism 142.

The acceleration sensor 146 detects acceleration occurred in the pendulum mechanism 14 and transmits a detection signal to the pendulum ECU 147.

The pendulum ECU 147 executes various kinds of control. Based on the detection signals acquired from the position sensor 145 and the acceleration sensor 146, the pendulum ECU 147 controls the left-right pendulum drive unit 143 and the front-rear pendulum drive unit 144 to cause the upper body 11 to perform pendulum motion so that an object placed on the upper surface (top plate) of the upper body 11 does not fall due to the acceleration occurred in the autonomous traveling robot R.

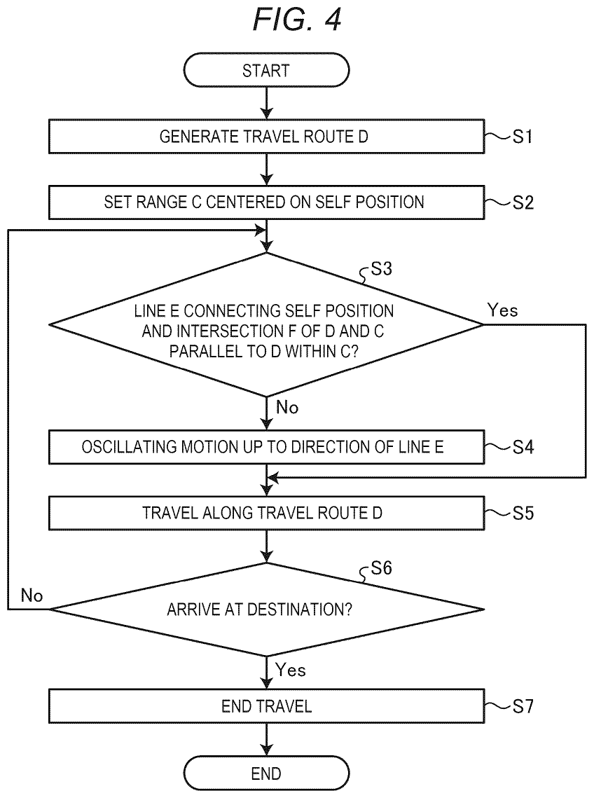

Next, processing executed by the autonomous traveling robot R will be described with reference to FIG. 4. FIG. 4 is a flowchart showing processing executed by the autonomous traveling robot R according to the embodiment.

In step S1, the traveling ECU 25 generates a travel route D (FIG. 3) from a current position to a destination based on the current position, the destination, and a position of an obstacle.

Next, in step S2, the oscillating ECU 133 sets the range C (FIG. 3) centered on a self position (a position of the autonomous traveling robot R).

Next, in step S3, the oscillating ECU 133 determines whether the line E (not shown in (a) and (e) in FIG. 3) connecting the self position (points P1 to P5 in FIG. 3) and the point F that is the intersection of the travel route D and the boundary of the range C is parallel to the travel route D within the range C. In a case of Yes, the oscillating ECU 133 proceeds to step S5, and in a case of No, the oscillating ECU 133 proceeds to step S4.

In step S4, the oscillating ECU 133 controls the oscillating drive unit 131 to cause the rotation mechanism 13 (and thus the transport unit 1) to perform oscillating motion up to a direction of the line E.

In step S5, the traveling ECU 25 controls the traveling drive unit 22 to cause the traveling unit 2 (and thus the autonomous traveling robot R) to travel along the travel route D.

Next, in step S6, the traveling ECU 25 determines whether the autonomous traveling robot R arrives at the destination, and in a case of Yes, proceeds to step S7, and in a case of No, returns to step S3.

In step S7, the traveling ECU 25 controls the traveling drive unit 22 to stop, and ends the travel of the autonomous traveling robot R.

Thus, according to the autonomous traveling robot R in the present embodiment, when the autonomous traveling robot R turns and moves in either the left direction or the right direction to move to the destination, the transport unit 1 is caused to perform oscillating motion in the same direction to be brought into an oscillating state, similar as in the case of the above-described employee ((b), (c), and (d) in FIG. 3). Accordingly, it is possible to make a person at the destination to recognize at an early stage that the autonomous traveling robot R is moving to a place of the person.

In the autonomous traveling robot R, when the autonomous traveling robot R is caused to perform oscillating motion to be brought into an oscillating state, the transport unit 1 is caused to perform oscillating motion to a position where the front surface of the transport unit 1 directly faces the destination at a maximum, so that the motion becomes closer to that of the above-described employee. Accordingly, it is possible to make a person at the destination to recognize at an early stage, without a sense of discomfort, that the autonomous traveling robot R is moving to a place of the person.

A program executed by the autonomous traveling robot R in the present embodiment can be provided in a form of an installable or executable file recorded on a recording medium readable by a computer device, such as a compact disc (CD)-read only memory (ROM), a flexible disk (FD), a CD-recordable (R), or a digital versatile disk (DVD). The program may be provided or distributed via a network such as the Internet.

While the embodiment disclosed here has been described above, the embodiment has been presented by way of example only, and is not intended to limit the scope of the disclosure. Novel embodiments can be implemented in various forms, and various omissions, substitutions, and modifications can be made without departing from the gist of the disclosure. The accompanying claims and their equivalents are intended to cover such embodiments or modifications as would fall within the scope and spirit of the disclosure.

For example, the acceleration sensor 146 may be provided not in the pendulum mechanism 14 but in the traveling unit 2. In this case, the acceleration sensor 146 does not detect acceleration due to pendulum motion by the pendulum mechanism 14 or rotational motion by the rotation mechanism 13, but the pendulum ECU 147 can determine control contents for the left-right pendulum drive unit 143 and the front-rear pendulum drive unit 144 by using not only a detection signal from the acceleration sensor 146, but also previous control signals from the pendulum ECU 147 to the left-right pendulum drive unit 143 and the front-rear pendulum drive unit 144, and a previous control signal from the oscillating ECU 133 to the oscillating drive unit 131.

On the other hand, as in the above-described embodiment, when the acceleration sensor 146 is provided in the pendulum mechanism 14, the acceleration sensor 146 detects acceleration due to pendulum motion by the pendulum mechanism 14 or rotational motion by the rotation mechanism 13, and thus such complicated processing is unnecessary. That is, control contents for the left-right pendulum drive unit 143 and the front-rear pendulum drive unit 144 can be determined by simple processing based only on the detection signal from the acceleration sensor 146.

This disclosure can be widely applied to autonomous mobile bodies in general other than the autonomous traveling robot.

An autonomous mobile body according to the present embodiment includes: a traveling unit including a drive wheel and a chassis and configured to move straight and turn and move in a left and right; a second unit disposed at an upper portion of the traveling unit and including a top plate and an oscillating mechanism for performing oscillating motion of moving around a vertical axis with reference to the traveling unit; and a control unit configured to, upon causing the autonomous mobile body to move to a destination, when the autonomous mobile body turns and moves in either a left direction or a right direction, execute control to cause the second unit to perform oscillating motion in the same direction to bring the second unit into an oscillating state, and to perform oscillating motion in an opposite direction before changing from turning movement to straight movement to cause the second unit to return from the oscillating state to a non-oscillating state.

According to the present embodiment, it is possible to make a person at the destination recognize at an early stage that the autonomous mobile body is moving to a place of the person.

The principles, preferred embodiment and mode of operation of the present invention have been described in the foregoing specification. However, the invention which is intended to be protected is not to be construed as limited to the particular embodiments disclosed. Further, the embodiments described herein are to be regarded as illustrative rather than restrictive. Variations and changes may be made by others, and equivalents employed, without departing from the spirit of the present invention. Accordingly, it is expressly intended that all such variations, changes and equivalents which fall within the spirit and scope of the present invention as defined in the claims, be embraced thereby.

What is claimed is:

1. An autonomous mobile body comprising:
a traveling unit including a drive wheel and a chassis and configured to move straight and turn and move in a left and right;
a second unit disposed at an upper portion of the traveling unit and including a top plate and an oscillating mechanism for performing oscillating motion of moving around a vertical axis with reference to the traveling unit; and
a control unit configured to, upon causing the autonomous mobile body to move to a destination, when the autonomous mobile body turns and moves in either a left direction or a right direction, execute control to cause the second unit to perform oscillating motion in the same direction to bring the second unit into an oscillating state, and to perform oscillating motion in an opposite direction before changing from turning movement to straight movement to cause the second unit to return from the oscillating state to a non-oscillating state.

2. The autonomous mobile body according to claim 1, wherein
when the autonomous mobile body turns and moves in either the left direction or the right direction, upon causing the second unit to perform oscillating motion in the same direction to bring the second unit into an oscillating state, the control unit executes control to cause the second unit to perform oscillating motion up to a position where a front surface of the second unit directly faces the destination at a maximum.
